(19) United States
(12) Patent Application Publication
(10) Pub. No.: US 2013/0129027 A1
(43) Pub. Date: May 23, 2013

(54) High Flux Neutron Source

(71) Applicants: Richard Harris Pantell, Portola Valley, CA (US); Charles Kevin Gary, Palo Alto, CA (US); Melvin Arthur Piestrup, Woodside, CA (US)

(72) Inventors: Richard Harris Pantell, Portola Valley, CA (US); Charles Kevin Gary, Palo Alto, CA (US); Melvin Arthur Piestrup, Woodside, CA (US)

(21) Appl. No.: 13/533,467

(22) Filed: Jun. 26, 2012

Related U.S. Application Data
(60) Provisional application No. 61/629,532, filed on Nov. 21, 2011.

(51) Int. Cl. G21G 1/06; G21G 1/10

(52) U.S. Cl. 376/158; 376/190

(57) ABSTRACT

An apparatus for producing thermal or epithermal neutrons in a sample has a plurality of fast neutron sources positioned around a cylindrical or spherical moderator to maximize the neutron flux at a sample placed in a void at the center of the moderator.

### CROSS REFERENCED TO RELATED APPLICATIONS

This application is a non-provisional application of provisional patent application Ser. No. 61/629,532, filed Nov. 21, 2011 by the present inventors.

### BACKGROUND OF THE INVENTION

1. Field of the Invention

The present invention is in the technical area of generating high fluxes of neutrons and their use for irradiation, identification and quantification of elements in materials.

2. Description of the Related Art

In the prior art high fluxes of neutrons were obtained from nuclear reactors, accelerators, and fusion reaction neutron generators. These fluxes of neutrons are used for neutron activation analysis (NAA) and prompt gamma neutron activation analysis (PGNAA) for determining the concentrations of elements in many materials. NAA and PGNAA allow discrete sampling of elements as they disregard the chemical form of a sample, and focus solely on nuclei of atoms in the sample. In both techniques samples are bombarded with thermal neutrons, causing the nuclei of the samples to form radioactive isotopes. By measuring spectra of emissions of these now radioactive samples, one can determine concentrations of elements within the sample. A particular advantage of this technique is that it does not destroy the sample, and thus has been used for analysis of works of art and historical artifacts, for example. Other applications are possible for high fluxes of neutrons. These include, but are not limited to, the production of medical and industrial isotopes and the sterilization of food, blood components and drugs.

Nuclear reactors and accelerators can produce large fluxes of neutrons, but they are large and expensive and have considerable safety considerations that must be addressed in operation. These issues limit the use of these sources to a few government and regionally sponsored facilities. To be useful commercially to a larger community of scientists, engineers and businesses, a neutron source must be made small enough for small laboratories and with sufficient neutron flux for element identification.

Fusion generators produce fast neutrons from deuterium-deuterium (DD) or deuterium-tritium (DT) reactions and are, in general, smaller and less expensive than accelerators and reactors. These fast neutrons must be moderated or slowed down to thermal or epithermal neutron energies using, for example, water or other hydrogen bearing materials. Previous attempts at doing this used single fast neutron generators that were simply surrounded by moderating materials with samples placed a short distance away from the moderator. Unfortunately, this resulted in low fluxes of neutrons at the sample, which could not activate materials in short enough times for most scientific and commercial purposes.

Previously, the placement of a fast neutron generator in a moderator and the volume of the moderator displaced by the generator limit the flux that can be obtained at the sample. The volume and geometry of a fast neutron generator are determined by its main components: the plasma ion source and the target. The generator is primarily a two component vacuum tube or diode. The plasma ion source produces the charged deuterium (D⁺) and/or tritium (T⁺) ions) that are accelerated toward a target using an electric field obtained by biasing the target to highly negative potential. The negative potential attracts the positively charged particles to the target. Targets can be flat, “V” shaped, cylindrical or spherical. The target is made of copper on which a thin layer of titanium is deposited. The implanted hydrogen ions form titanium hydrates in the titanium matrix, thus ‘trapping’ the deuterium and tritium atoms into the matrix. Other materials can be used for the target such as molybdenum. When the generator is operating, the titanium layer is initially being loaded with deuterium or tritium and the neutron output is increasing with time; then after some minutes of operation the target is loaded by the incoming ions and the neutron output saturates to a stable level.

In the prior art, a cylindrical fast neutron generator has been constructed using a coaxial radio frequency (RF) driven plasma ion source with a cylindrical target. Deuterium (or deuterium and tritium) plasma is produced by RF excitation in a cylindrical plasma ion generator using an RF antenna. In the prior art, the RF plasma is formed using a loop antenna that is immersed inside the plasma gas. The neutron generating target is coaxial with the ion generator, separated by plasma and extraction electrodes which contain many slots. The plasma generator emits ions radially over 360° and the cylindrical target is thus irradiated by ions over most, or all, of its entire circumference. The neutron target surrounds the cylindrical plasma ion source or is positioned inside an annular shaped plasma ion source. In both cases the ion source and the target are coaxial or concentric.

The minimum size of the fast neutron generator is determined by the size of the titanium target and the generator housing producing the neutrons. The target must be large enough that it is not heated by the ion beam past 300 to 500 watts/cm². This value depends strongly on the method of cooling the target (e.g. liquid circulating in the target, convection cooling with air). This is only approximate and has been determined experimentally. If this power density is exceeded, deuterium atoms will be evaporated off, no fusion reaction can take place and no neutrons will be produced. The size of the target determines the size of the generator.

Shown in FIG. 1 is a PGNAA system 10 in the prior art for the detection, identification and quantification of atomic elements in a material. The PGNAA system 10 is in the prior art and consists of a cylindrical fusion generator 16 placed inside a cylindrical moderator 24, which is in turn surrounded by a fast neutron reflector 22 and a biological radiation shield 14. A cylindrical sample chamber 20 containing a sample is placed a distance R from the cylindrical fusion generator 16. Fast neutrons are emitted by the compact fusion generator 16 and moderated (slowed down to thermal energies) by the moderator 24. The thermal neutrons are captured by the sample 18 and characteristic gamma-rays are emitted by the sample 18. A pipe 06, placed perpendicular to the radial line from sample chamber 20 to the cylindrical fusion generator 16, conducts some of the gamma-rays 04 to a gamma-ray detector 12, where the gamma-ray energy of the emitting element in the sample is measured and identified.

To maximize the use of the available neutrons, the fast neutron reflector 22 is used to reflect fast neutrons back into the moderator 24. The fast neutron reflector 22 also absorbs gamma and x-ray radiation to protect the generator operator and reduces spurious gamma-ray emission from striking the gamma-ray detector 12. The fast neutron reflector 22 can be made of lead or bismuth. The biological radiation shield 14 is additional shielding to absorb or reduce thermal and fast neutrons and is made of materials such as borated polyethylene (i.e. Borate) or additional gamma shielding to protect the generator operator and reduce spurious radiation.

The Prior Art arrangement of FIG. 1 has low collection efficiency since the gamma-rays are being emitted in all directions (i.e. the sample becomes an isotropic source of gamma-rays) and the sample chamber 20 is a long distance D from the gamma-ray detector 12. Only a few gamma-rays 04 will be collected by the gamma-ray detector 12, and the sensitivity of the device is reduced. In addition, since the compact fusion generator takes up moderator volume (e.g. diameter=40 cm) there is less moderation of the fast neutrons being emitted by the cylindrical fusion generator 16, and the thermal neutron flux at the sample is reduced.

The position R of the maximum thermal flux at sample chamber 20 in a moderator made of high density polyethylene (HDPE) was calculated to be approximately R=5 cm from the point source (assumes the diameter of the fast neutron source to be =0). The thermal flux was calculated at the sample chamber to be 7×10⁸ n/sec-cm² for the point source (no volume displacement) emitting 10¹¹ n/s. However, if one uses a more realistic value for a generator diameter of 40 cm, then the optimum R=10 cm, and the calculated flux is reduced to 6×10⁷ n/sec-cm², a factor of at least an order of magnitude reduction in yield from the point source calculation. To achieve the same flux as the point source, one must increase the yield of the fast neutron generator an order of magnitude to 10¹² n/s. Previously, one could do this only by increasing the HV power to the generator head, which is limited by cost and size.

In summary, the placement, R, of the sample chamber 20 relative to a finite size cylindrical fusion generator 16 reduces the thermal flux to the sample. In addition, the distance D of the gamma-ray detector 12 from the sample chamber 20 also reduces the number of gamma-rays striking the detector and, subsequently, reduces the sensitivity of the PGNAA system 10 to identify samples. One might assume that to increase the neutron flux, one need only increase the fast neutron yield from the generator by increasing the high voltage power consumed by the generator, provided there is adequate cooling of the target from the ion bombardment. This, however, is limited by the conversion efficiency of the fusion process and the high cost of electrical power and high voltage electronics. At 100 keV, the neutron yield is roughly 10⁸ n/sec per mA for the DD fusion reaction and 10¹⁰ n/sec per mA for the DT reaction. High voltage power supplies of 1 MW can be fabricated, but 1 MW of power is required to drive them. This is excessively large power for a clinic or hospital, requiring not only large input powers for the high voltage supply, but also large refrigeration systems for cooling the generator. Other issues such as high voltage arcing and, consequently, component destruction can occur at such high powers.

### SUMMARY OF THE INVENTION

In one embodiment the invention is a cylindrical neutron generator formed with fast neutron sources arranged concentrically around a cylindrical moderator with a central sample chamber placed at the center of the moderator. The multiple fast neutron sources are achieved by multiple generators or multiple ion beams striking a centrally placed cylindrical titanium target that surrounds, and is concentric with, a cylindrical moderator.

In one embodiment a multi-ion beam neutron generator is formed with plasma ion sources which direct their ion beams inwardly to a cylindrical target where fast neutrons are generated. A cylinder of moderating material is placed inside the target cylinder. The moderating material reduces the energy of neutrons to thermal energies and produces a high thermal neutron flux density inside the moderating cylinder. Materials to be irradiated are placed inside a void (sample chamber) at the center of the moderator. The material and the radius of the moderator are selected to maximize the thermal neutron flux at the center of the moderator where the sample to be irradiated is placed. High fluxes of neutrons can be achieved with realistic HV power levels.

Depending upon the neutron generator's desired use, the moderator can be replaced with another size and material, permitting the apparatus to be used for other neutron energies. The moderator can be completely removed. Without the moderating cylinder the neutrons will have higher energy (fast neutrons). Thus, the multi-ion beam generator can be used to produce high flux densities of thermal, epithermal or fast neutrons. In the art the following definitions of neutron energy ranges are used: Fast (E>1 MeV), Epithermal (0.5 eV<E<1 Mev) and Thermal (E<0.5 eV) neutrons.

Alternative embodiments depend at least in part upon selection of the plasma ion source that is used to generate the neutrons at the cylindrical target. Three alternatives with their respective geometries are presented. These are (1) the RF-driven plasma ion source using a loop RF antenna, (2) the microwave-driven electron cyclotron resonance (ECR) plasma ion source, and (3) the RF-driven spiral antenna plasma ion source. Not presented are a multicusp plasma ion source and a Penning diode plasma ion source, which can also be used for replacement ion sources for the three embodiments. All plasma ion sources can be used to create deuterium or tritium ions for fast neutron generation.

The term “neutron generator” is intended to cover a wide range of devices for the generation of neutrons. The least expensive and compact generator is the “fusion neutron generator” that produces neutrons by fusing isotopes of hydrogen (e.g. tritium and deuterium) by accelerating these isotopes together using modest acceleration energies (e.g. 60 to 200 keV). Various fusion reactions can occur, depending upon the mixture of isotopes used (e.g. DD, DT or TT). These fusion neutron generators are compact and relatively inexpensive compared to linear accelerator devices such as the spallation neutron sources now used in several national laboratories both in the US and abroad. However, these larger, more expensive sources of neutrons can also be used to produce high flux densities of neutrons using the methods described in the present embodiments.

In short, embodiments of the present invention use a plurality (n≧2) of neutron or ion sources in symmetrical arrangements (e.g. cylindrical or spherical) to produce high fluxes of fast, epithermal and thermal neutrons.

### BRIEF DESCRIPTION OF THE DRAWINGS

FIG. 1 (prior art) is a cross sectional view of a prompt gamma neutron activation analyzer;

FIG. 2a is a perspective view of how multiple fast neutron generators are used to develop a high thermal neutron flux density at a sample;

FIG. 2b is a cross sectional view of how fast neutron illuminated cylindrical moderator develops a high thermal neutron flux density at a sample;

FIG. 3a is a graph of the expected thermal neutron flux as a function of moderator thickness for various moderating materials;

FIG. 3b is a graph of the ratio of thermal to fast neutrons as a function of moderator thickness for various moderating materials;

FIG. 4a is a perspective view of how radially-inward deuterium ions D⁺ develop a high thermal neutron flux density at a sample;

FIG. 4b is a cross sectional view of how radially-inward deuterium ions D⁺ develop a high thermal neutron flux density at a sample;

FIG. 4c is a cross sectional view of how radially-inward deuterium ions D⁺ illuminate at segmented locations on a cylindrical target and produce a high thermal neutron flux at a sample;

FIG. 5 is a graph of the thermal neutron flux as a function of radial position across a sample comparing a cylindrical and segmented illumination of deuterium ions D⁺;

FIG. 6a is a cross section view of how radially-inward deuterium ions D⁺ are produced using a large loop RF-antenna-driven plasma ion source;

FIG. 6b is a perspective view of how radially-inward deuterium ions D⁺ are produced using a spiral-antenna-driven plasma ion source;

FIG. 7a is a cross section view of how radially-inward deuterium ions D⁺ are produced using multiple microwave-driven plasma-ion sources;

FIG. 7b is a perspective view of how radially-inward deuterium ions D+ are produced using multiple microwave-driven plasma-ion sources;

FIG. 8 is a perspective view of how radially-inward deuterium ions D+ are produced using multiple spiral-antenna-driven plasma ion sources;

FIG. 9 is a cross sectional view of a prompt gamma neutron activation analyzer using multi-beam neutron generator, moderator and gamma-ray detector.

### DETAILED DESCRIPTION OF THE INVENTION

In the following descriptions of embodiments of the invention, reference is made to the accompanying drawings that form a part thereof, and in which are shown by way of illustration specific embodiments in which the invention may be practiced. It is to be understood that other embodiments may be utilized and structural changes may be made without departing from the scope of the present invention.

### Multiple Fast Neutron Generators Surround a Sample

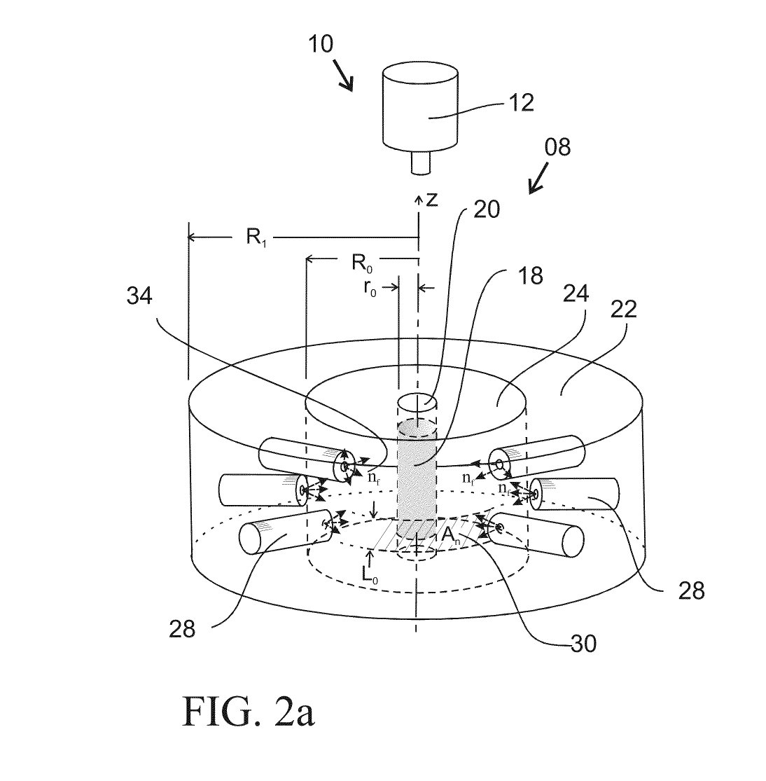

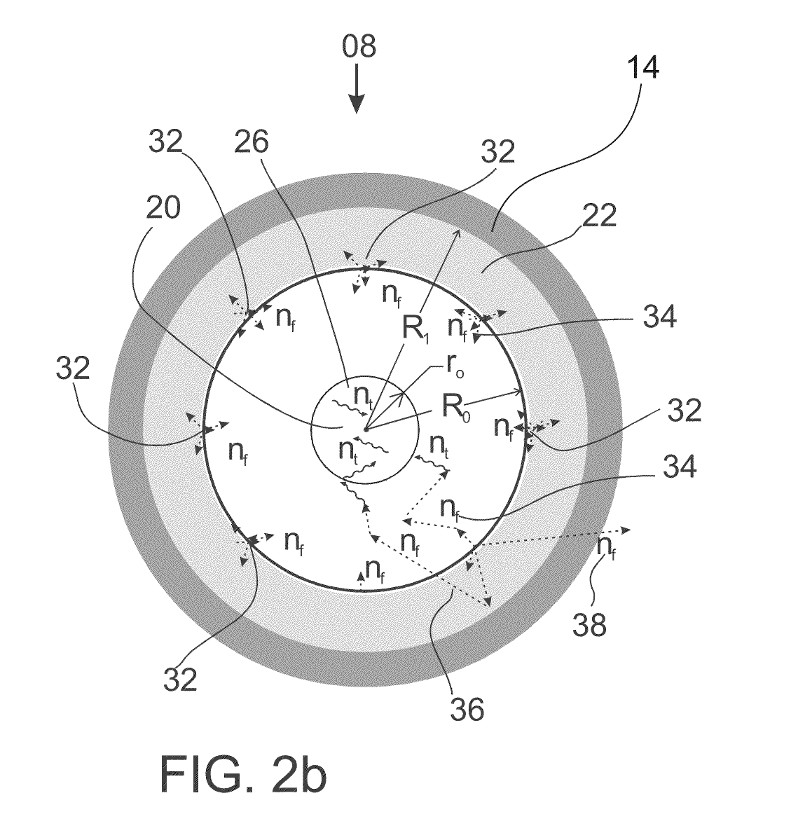

FIG. 2a is a stylized high-level perspective view of a high flux neutron source 08 according to an embodiment of the present invention, and is used to illustrate salient features that can be viewed as generic to various embodiments discussed below. Adding a gamma-ray detector 12 positioned along the z-axis of the high flux neutron source 08, makes a PGNAA system 10. Main components of the high flux neutron source 08 include fast neutron generators 28, a sample chamber 20, a cylindrical moderator 24, and one or more fast neutron reflector elements 22. The sample chamber 20 is configured to accept small samples 18 of materials to be irradiated with high fluxes of neutrons for the purposes of identification, activation or sterilization.

A high flux of thermal or epithermal neutrons at the sample chamber 20 is achieved by placing a moderator 24 in the shape of an annulus inside the fast neutron generators 28, which ring the moderator 24. Fast neutrons 34 are emitted from the fast neutron generators 28 positioned in a circle at a radius Rₒ from the center of the sample chamber of radius rₒ. The fast neutrons irradiate a cylindrical surface area 30 of approximately Aₙ=27π RₒLₒ, forming a cylindrical strip of width Lₒ completely around the moderator 24. Fast neutron irradiation can be non-uniform around the cylindrical surface area 30.

In one embodiment, the fast neutron generators are embedded in a fast neutron reflecting material such as lead, which both acts as fast neutron reflector 22 and radiation shield. Besides re-introducing the fast neutrons back into the moderation process, the fast neutron reflector 22 minimizes gamma radiation, x-ray and neutrons from the immediate environment surrounding the neutron source.

In one embodiment, high density polyethylene (HPDE) is used as the moderator 24 because of its high density of hydrogen atoms, which quickly slow down the fast neutrons to thermal energies. This quick moderation of the fast neutrons by the HPDE achieves a high density of thermal neutrons concentrated at the center of the moderator at the sample chamber 20.

A cross section of the moderating process is shown in FIG. 2b. The neutron generators (not shown) emit the fast neutrons 34 isotropically in all directions around the edge of the moderating material at neutron emission points 32. These points 32 can be continuous around the circumference of the cylindrical moderator 24. The fast neutrons (e.g. 34) that are emitted directly into the moderator 24 are elastically scattered by the hydrogen atoms in the HDPE where they are slowed down to thermal energies (e.g. E≦0.5 eV). The concentration of fast neutrons into the moderator results in the maximum flux of thermal neutrons 26, nₜ, to be obtained at the center of the moderator where the sample chamber 20 is located.

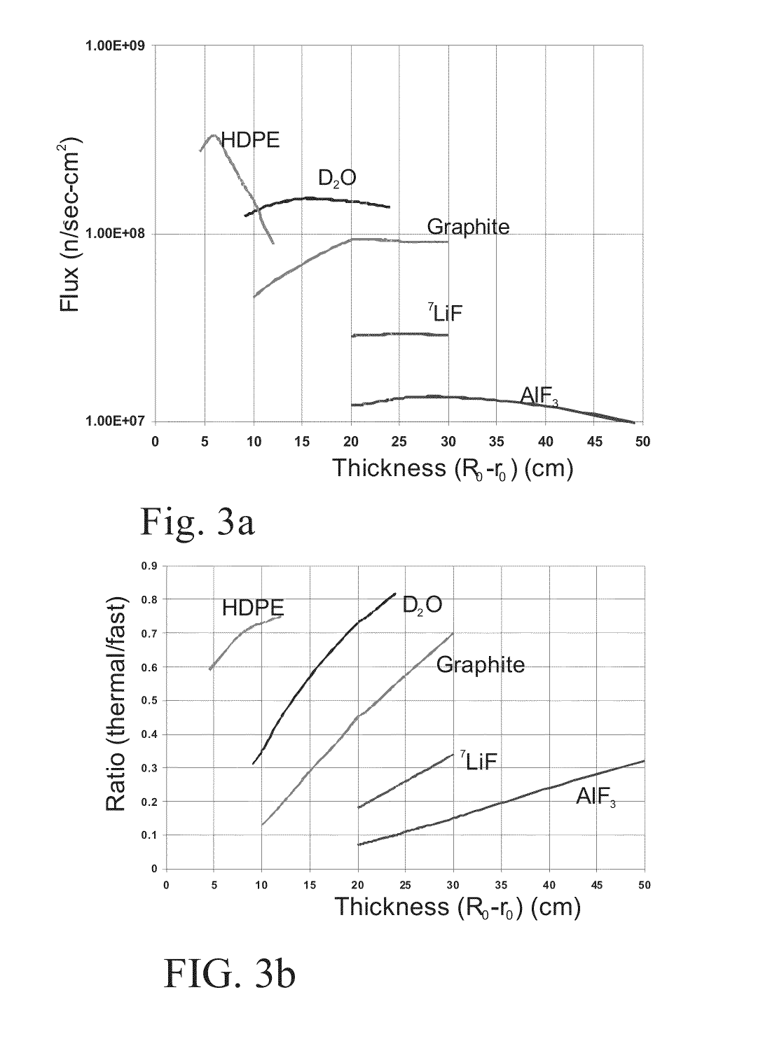

There are a number of materials one could select for moderator 24 to achieve maximum thermal neutron flux at sample chamber 20. However, HDPE gives the maximum thermal neutron flux. The performance of HDPE, heavy water (D₂O), graphite, ⁷LiF, and AlF₃ was analyzed using a Monte Carlo Neutral Particle (MCNP) simulation. The results are given in FIG. 3a, which shows the calculated thermal neutrons/(cm²-s) for these materials as a function of moderator thickness (R-rₒ), where the central hole rₒ=2.5 cm, the neutron source length in the z direction is Lₒ=10 cm and the Pb reflector is R₁-Rₒ=50 cm thick. The combined fast neutron yield striking the area from all the fast neutron generators 28 is assumed in the MCNP to be 10¹¹ n/s. The maximum thermal flux at the sample is a linear function of fast neutron yield from all the generators 28.

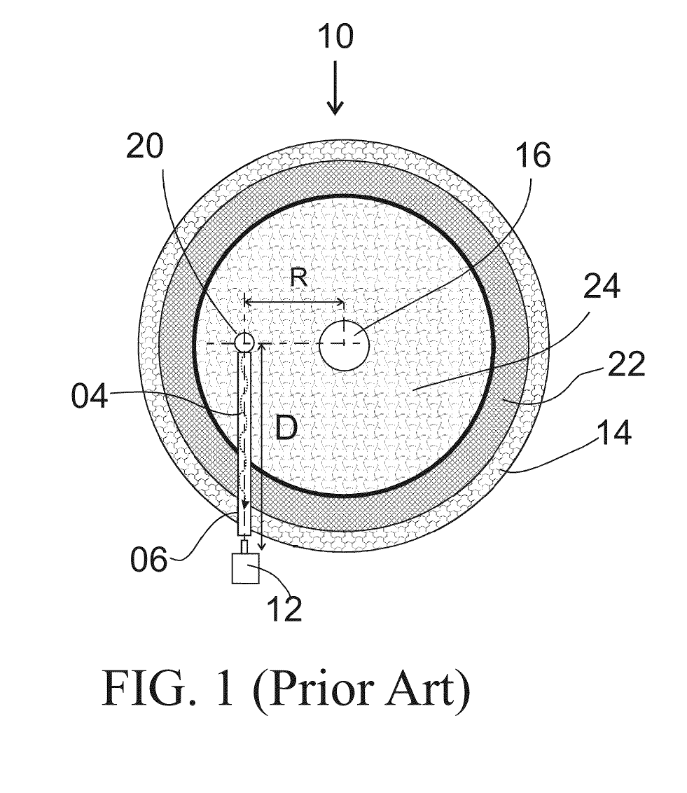

As can be seen from FIG. 3a, the moderating material HPDE gives the maximum flux, when the moderator thickness Rₒ-rₒ is approximately 6 cm. The maximum flux at the center of the sample chamber 20 is calculated to be 6×10⁸ n/(cm²-sec), much higher (order of magnitude) than would be achieved using the Prior Art geometry shown in FIG. 1 with the same yield of 10¹¹ n/s. Changing the thickness of the fast neutron reflector 22 does not appreciably change the maximum flux at the center of the sample chamber 20.

As used in this application, the term “neutron generator” is defined more broadly to include any device that provides a sufficient number of neutrons of desired energies. Besides the fusion neutron generators, this could include, but is not limited to, (1) a “Dense Plasma Focusing Device” that pinches or compresses the isotopes of hydrogen to produce fast neutrons; (2) a “bremsstrahlung source with converter target,” which uses bremsstrahlung radiation from an electron accelerator to interact with a neutron rich target to produce neutrons via the (γ, n) interaction; (3) a spallation source, which is a proton accelerator with a target such as carbon, beryllium or lithium, to produce neutrons via C-12(p,n), Be-9(p,n) reactions, for example.

### The Reflector and Shielding

Reflector 22 of radius R₁ is used to reflect the fast neutrons back into the moderator 24, and both shield users from the various radiations escaping from the generator 10. For example, lead or Bismuth can act as reflectors of the fast neutrons. The cross sectional view of FIG. 2b shows the process of moderating and reflecting of the fast neutrons. Fast neutrons are being introduced at the intersection of the moderator and shield at eight neutron emission points 32 around the perimeter of the moderator over the area of Aₙ=2π RₒLₒ. In FIG. 2b a reflected fast neutron 36 is being reflected back into the moderator by the fast neutron reflector 22. On the other hand, a fast neutron 38 is escaping outside the shielding into the environment and is lost to the moderating process.

In the general process of moderating and shielding, gamma-rays, x-rays and neutrons are produced. For some applications (e.g. shielding high purity geranium detectors from fast neutrons) and operator safety, these radiations must be minimized by shielding. As one skilled in the art knows, besides lead, various materials can be used for shielding from these radiations. Other applications may require no shielding, reducing the overall size of the neutron source.

FIG. 2b shows a biological radiation shield 14, which is used to block ionizing radiation such as alpha particles, gamma-rays and neutrons that might leak out of the neutron-reflecting shell. The biological radiation shield can be made of materials such as lead, iron, borated polyethylene or a combination of any or all of such materials. Indeed, lead can perform both the fast neutron reflector function and the biological shield function.

### Other Neutron Energy Components

Depending upon the energy of the fast neutrons and the thickness and material of the moderator, there are other component energies contained in the neutron flux inside moderator 24 and at sample chamber 20. This has been simulated for the same moderating material used in FIG. 3b. The ratio of thermal neutron flux to fast neutron flux is plotted as a function of moderator thickness (Rₒ-rₒ), where the central hole rₒ=2 cm, the neutron source length in the z direction is Lₒ=10 cm and the Pb reflector is R₁-R₀=50 cm thick. The combined fast neutron yield striking the area from all the fast neutron generators 28 is assumed in the MCNP to be 10¹¹ n/s.

FIG. 3b shows that higher ratios of thermal to fast neutrons are achieved by going to thicker (Rₒ-rₒ) moderating materials. This also reduces the flux of thermal neutrons as shown by FIG. 2a. For example, going to Rₒ-rₒ=12 cm of HDPE increases the thermal-to-fast neutron ratio to 0.75 from 0.63, but with a reduction of flux from 6×10⁸ to 1×10⁸ n/s-cm².

Other materials can give higher ratios of thermal to fast neutrons. Using heavy water, D₂O, can increase the thermal to fast neutron ratio without appreciable loss of thermal neutron flux. This is shown in FIGS. 3a and 3b, where making the D₂O moderator Rₒ-rₒ=25 cm thick reduces the thermal neutron flux by only 5 to 10%, while increasing the ratio of thermal neutrons to fast neutrons to 84%.

The arrangement of FIGS. 2a and 2b can also be used to increase the maximum epithermal neutron flux generator by the proper selection of moderator material 24 and thickness (R₀-r₀). If HDPE is used, cylindrical moderator 24 is compact and easily removed. Replacing the HDPE cylindrical moderator with thinner (smaller Rₒ-rₒ) HDPE, high fluxes of epithermal neutrons can be obtained at sample chamber 20. Maximum fast neutron flux can also be achieved by removing cylindrical moderator 24 altogether. The ability to remove or replace the cylindrical moderator makes the high flux neutron source 08 of FIG. 2a into a multi-purpose source of thermal, epithermal or fast neutrons.

High Thermal Neutron Flux Source Using a Cylindrical Target with Distributed Ion Beams

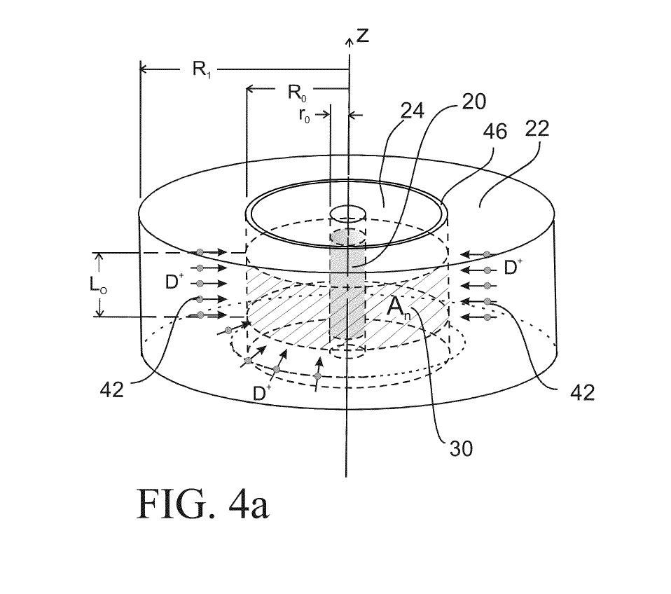

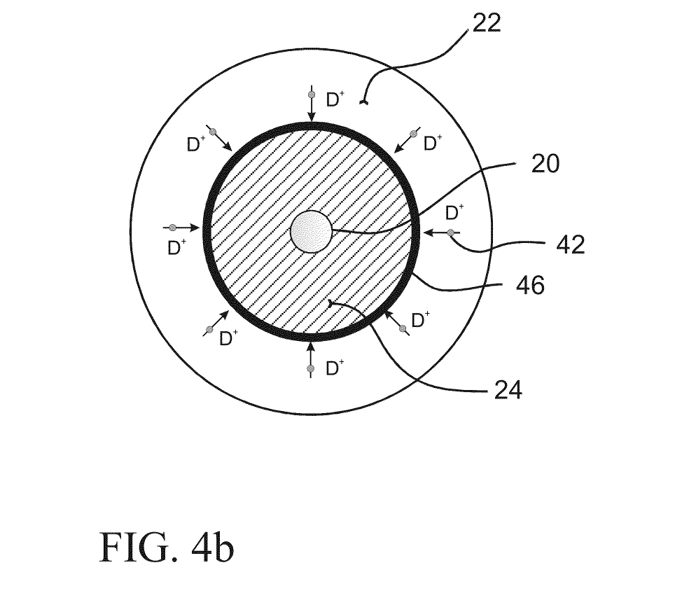

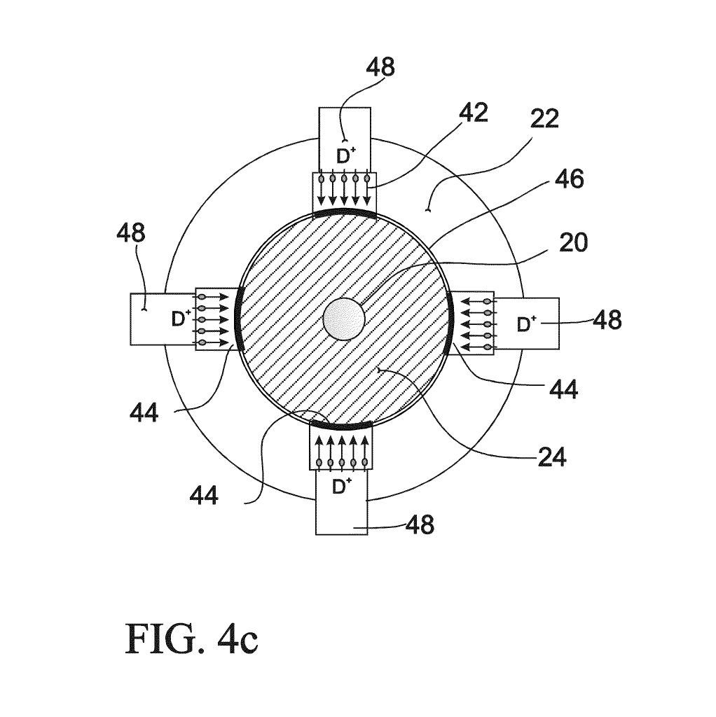

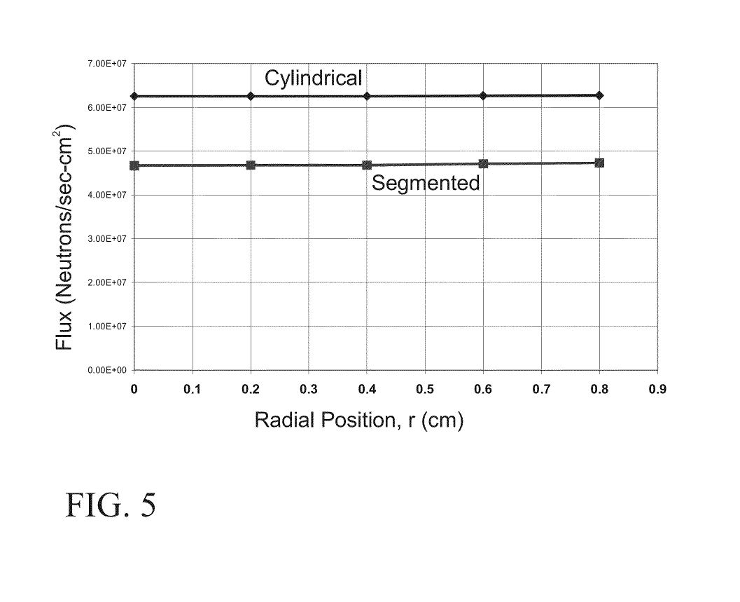

FIG. 4a is a stylized high-level perspective view of a high flux neutron source 10 according to a second embodiment of the present invention, and is used to illustrate salient features that can be viewed as generic to various embodiments discussed below. The main components of high flux neutron source 08 include a cylindrical titanium target 46, a sample chamber 20, a cylindrical moderator 24, and for various embodiments, one or more fast neutron reflectors 22 made of materials such as lead or Bismuth. Cylindrical titanium target 46 is contiguous with cylindrical moderator 24. Deuterium ion beams 42 are directed toward titanium target 46. The deuterium D⁺ ions can be produced by a variety of ion sources, which are not shown in FIG. 4a in order to minimize the complexity of the drawing. Well known ion sources include, but are not limited to, RF-driven ion and microwave-driven ion sources. These sources and their geometries relative to the moderator and target are given in FIGS. 5a, b and c.

In FIG. 4a, multiple deuterium ion beams 42 are produced and converge onto a cylindrical titanium target 46 of radius R₀. In the interior of the cylindrical titanium target 46 is an annular moderator 24 composed of HDPE in which a sample chamber 20 of radius rₒ is centered. Cylindrical titanium target 46 is assumed to be irradiated with deuterium ion beams 42 over the entire circumference and in the vertical direction Lₒ of 10 cm. Thus the ions irradiate over a cylindrical surface area 30 of Aₙ=2π RₒLₒ. Fusion of the hydrogen isotopes takes place over this area and fast neutrons are emitted. Thus the surface area Aₙ is identical to that of the surface area of embodiment shown in FIG. 2a.

In the embodiment of FIG. 4a cylindrical titanium target 46 is made of copper upon which a thin layer of titanium is deposited or bonded. Water or other cooling fluid flows through channels that move vertically through the copper target, cooling the target from the heat generated by the deuterium ions striking the cylindrical neutron generating target. These ions implant themselves in the titanium matrix, forming titanium hydrates and ‘trapping’ the deuterium. Subsequent ions strike the trapped deuterium ions, resulting in the deuterium-deuterium (DD) fusion reaction. Tritium can also be used to form either the deuterium-tritium (DT) or tritium-tritium (TT) fusion reactions, resulting in higher yields of neutrons at other energies (e.g. 14 MeV for the DT reaction).

FIG. 4b shows a cross section of the high flux neutron source 08 of the embodiment of FIG. 4a. Deuterium ion beams 42 are directed toward cylindrical titanium target 46. As in all fusion neutron generators, the deuterium ions fuse with other deuterium ions at the titanium target, resulting in fast neutrons that are emitted isotropically, flying out in all directions in a 4π solid angle. The target surrounds a cylindrical moderator 24, made of HDPE or other moderating materials. A large fraction of the fast neutrons are contained and slowed down inside the volume of the moderator 24. This concentrated flux of thermal neutrons will irradiate the sample 18.

### Segmented vs Cylindrical

With the exception of large RF antenna-driven plasma-ion sources, most ion sources are limited in ion-beam area, and thus flooding the entire cylindrical titanium target may not be optimal. However, using multiple ion sources distributed around the cylinder with segmented irradiation of the titanium target permits almost the same flux at the center of the sample as that produced by the irradiation of the full circumference.

FIG. 4c shows a stylized high-level cross sectional view of a high flux neutron source 08 according to an embodiment of the present invention. In this embodiment four ion sources 48 are arranged around a cylindrical titanium target 46. A larger number of ion beams 42 and sources 48 can be used. In our MCNP simulation, each of the four ion beams 42 is assumed to bombard areas 44 of 2 cm×2 cm. Other area of ion beam bombardment 44 are possible. In the simulation, the fast neutron reflector 22 is lead that is 20 cm thick, the HDPE moderator is R₀-r₀=4.4 cm thick, and the sample chamber 20 has a radius of r₀=1 cm. The four ion sources 48 provide a total 10¹⁰ n/s. The neutron flux for E<0.05 eV inside the sample chamber 20 is calculated in a plane (perpendicular to the z-axis) that is equidistant from the two ends of the sample chamber hole.

The results of the MCNP simulations are given in FIG. 5 for the case of segmented illumination and the complete cylindrical illumination by the ion beams 42. The thermal neutron flux for E<0.5 eV inside the sample chamber is plotted as a function of the radial distance, r, from the center of the sample for the two cases of a cylindrical and a segmented source. The ordinate of the graph shows that the flux from the cylindrical titanium target 46 is only 20% greater than from the segmented source, teaching that the segmented fast neutron source is an adequate substitute for the cylindrical source. This permits the use of either separate ion sources or neutron sources around the moderator without the loss of thermal flux.

Distributing the ion beam around the cylindrical titanium target reduces the per unit power deposited on the target. As stated above, if the amount of power deposited exceeds 500 watts/cm², then the deuterium ions are boiled out of the titanium, resulting in fewer fusion events and a loss of neutron yield. The cylindrical titanium target is kept cool by circulating water or another appropriate fluid to conduct heat out of the target.

### Methods of Ion Beam Production

There are a number of methods to heat a gas of hydrogen isotopes into a plasma in order to produce the hydrogen isotope ions (D⁺, T⁺) required for the fusion process. Three methods lend themselves to the cylindrical geometry used in FIGS. 5a and 5b. They present themselves as methods because they lend themselves to the spherical geometry and permit the use of a common vacuum system and plasma volume, reducing overall cost and the complexity of the generator.

### RF Loop Antenna Coupling

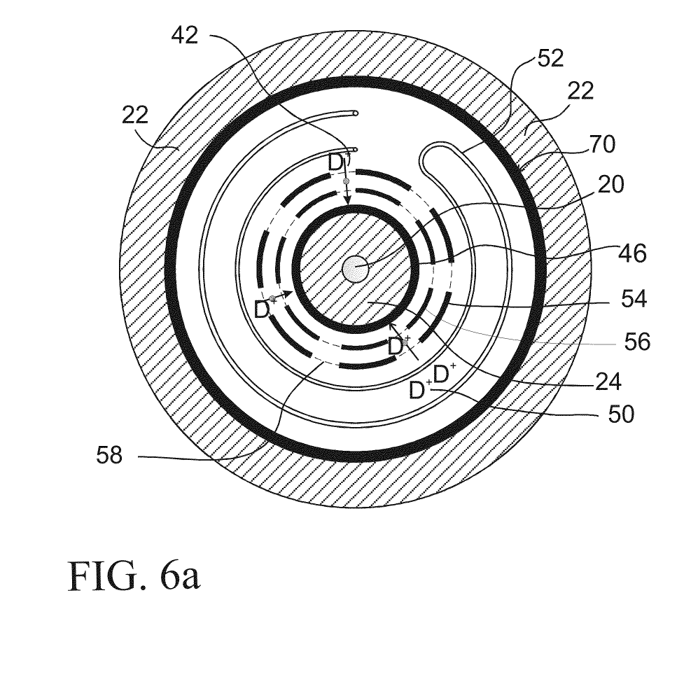

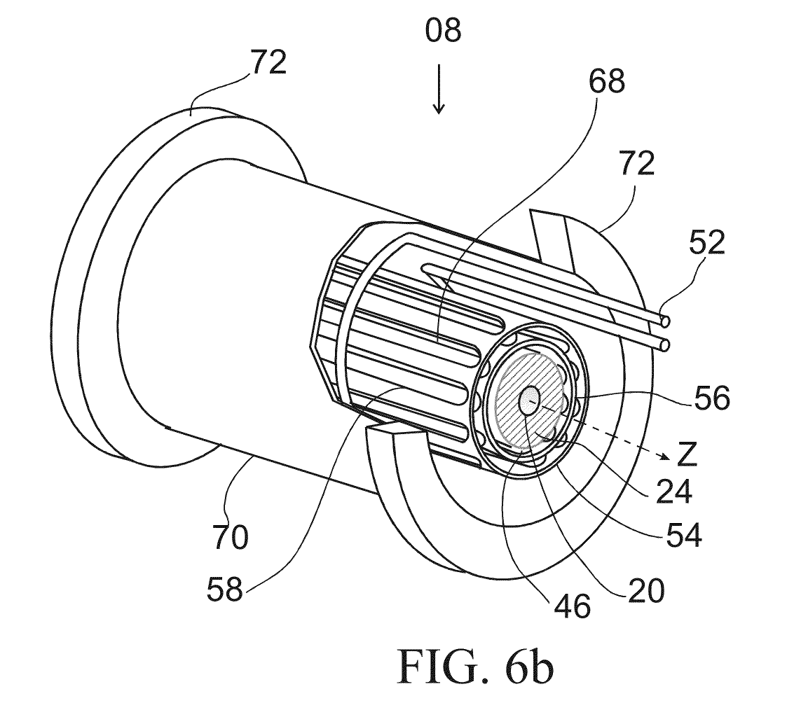

An embodiment of the high flux neutron source 08 using a cylindrical RF plasma ion source is shown in FIGS. 6a and b. FIG. 6a shows a cross section of thermal neutron source 08 with fast neutron reflector 22 present. FIG. 6b shows a stylized high-level perspective view of the high flux neutron source 08 without the fast neutron reflector. For illustrative purposes, end flanges 72 on cylinder housing 70 are shown in FIG. 2b, while not in FIG. 2a.

As shown in FIG. 6a, a large loop RF antenna 52 irradiates a deuterium gas contained in a cylindrical vacuum chamber 70. The fast neutron generator uses a similar cylindrical geometry of the fast neutron generator developed in the prior art. The space between the vacuum chamber 70 and an extraction iris 54 forms the region where the deuterium-ion plasma 50 occurs. Inside the extraction iris 54 is an electron shield 56 which deflects the electrons from striking extraction electrode 54. Extraction electrode 54 and the electron shield 56 are in the form of slots 58 whose length can be extended to any desired values. A titanium cylindrical target 46 is inside the electron shield 56 and contains a cylindrical titanium moderator 24 and the sample chamber 20.

Deuterium ion beams 42 are extracted from the plasma 50 by having the cylindrical titanium target 46 at a high negative voltage (e.g. −100 kV). An extraction electrode 54 is a cylindrical array of slots 58 that are at ground potential. Electron shield 56 is biased slightly higher than that of cylindrical target 46 at, for example, −102 kV. With this voltage difference between extraction electrode 56 and cylindrical titanium target 46, ion beam 42 is accelerated toward and impinges upon target 46. Fast neutrons are produced at the surface of cylindrical target 46 due to the fusion of the deuterium ions. These fast neutrons travel in all directions and enter into the moderator 24 or outwardly where they are reflected by the lead fast neutron reflector 22. Electrons produced at the cylindrical target 46 are deflected back by the electron shield 56 toward the cylindrical target 46. This deflection is caused by the 2 kV difference in voltage between the cylindrical target 46 and the electron shield 56. If the electrons were not deflected back, they would strike the extraction electrode at a full acceleration potential of 100 kV, causing heating, sputtering and oblation of the extraction electrode 54. The fast neutrons are slowed down in the moderator 24 to epithermal and thermal energies and arrive at the sample chamber 20 at high fluxes. This moderation and reflection process are shown diagrammatically in FIG. 2b.

### Multiple ECR Ion Sources

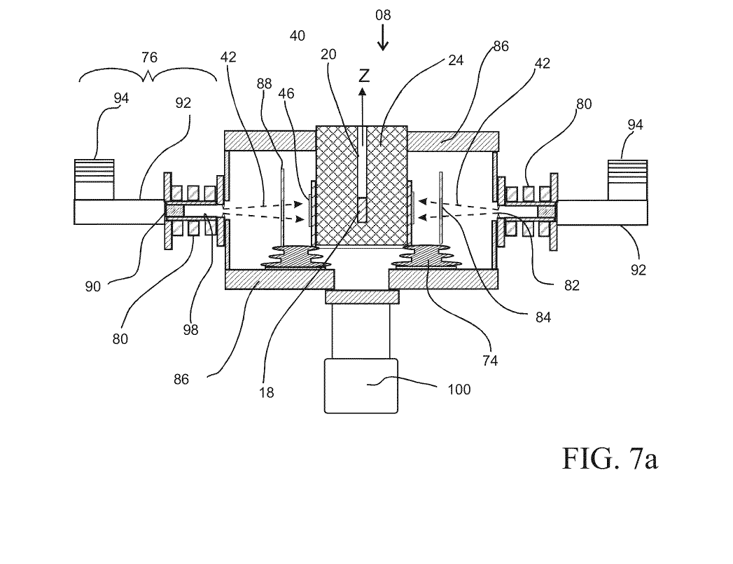

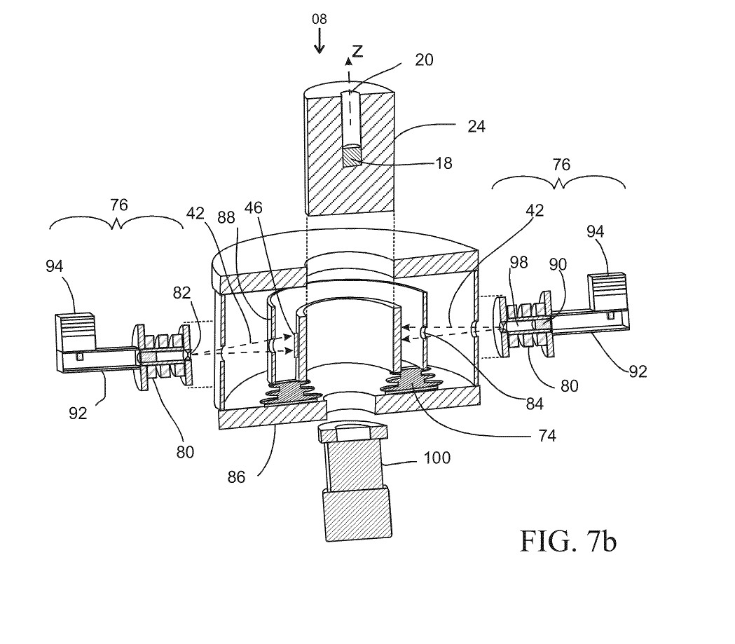

An embodiment of the thermal neutron source using multiple electron cyclotron resonance (ECR) ion sources 76 is shown in FIGS. 7a and 7b. FIG. 7a shows a cross section of the thermal neutron source 08 without the fast neutron reflector. FIG. 7b shows an exploded, stylized perspective cross sectional view of the thermal neutron source 08, again without the fast neutron reflector.

ECR ion source 76 consists of a magnetron 94 that supplies microwave energy to the deuterium plasma ion chamber 78 via a waveguide 92 and a microwave window 90. The microwave energy ionizes and heats the deuterium gas into a plasma 98, resulting in a high atomic content D⁺ and minimal molecular content D₂⁺. Plasma ions 42 are emitted from an extraction aperture 82. A strong axial magnetic field is produced by annular magnets 80. If the axial magnetic field is at the electron cyclotron resonance frequency, then electrons will spiral along the axis of the plasma chamber 78, colliding with the gas ions, resulting in a high degree of deuterium being ionized and a deuterium plasma 98 being formed. Extraction aperture 82 is a small iris at the end of plasma ion chamber 78. A deuterium ion beam 42 is extracted from the plasma 98 by having cylindrical titanium target 46 at a high negative voltage (e.g. −100 kV).

Outside extraction aperture 82 is an electron shield 56 which deflects the electrons from coming back and striking extraction aperture 82. These electrons are created by collisions of the deuterium ions with deuterium gas in the acceleration region and by deuterium beam 42 striking cylindrical titanium target 46. The titanium cylindrical target is inside electron shield 88 and contains a cylindrical moderator 24 and sample chamber 20.

Electron shield 88 is biased slightly higher than that of cylindrical titanium target 46 at, for example, −102 kV. With this voltage difference between extraction electrode 82 and cylindrical target 46, ion beam 42 is accelerated toward and impinges upon target 46. Fast neutrons are produced at the surface of cylindrical target 46 due to fusion of the deuterium ions. These fast neutrons travel in all directions, either entering into moderator 24 or exiting outwardly where they are reflected or absorbed by the lead reflector (not shown in FIGS. 7a and 7b). Electrons produced at cylindrical titanium target 46 are deflected back by electron shield 88 toward cylindrical target 46. This deflection is caused by the 2 kV difference in voltage between the cylindrical target 46 and electron shield 88. If the electrons were not deflected back, they would strike the extraction electrode at a full acceleration potential of 100 kV, causing heating, sputtering and oblation of the extraction electrode 82.

### Multiple Spiral Antenna Ion Sources

In accordance with a further embodiment of the present invention, an apparatus for producing thermal neutrons in a sample comprises multiple spiral antenna ion sources 62 with spiral antennas 64 supplying RF energy to ionize the deuterium gas and producing deuterium ion beams 42 which are accelerated to a cylindrical titanium target 46 over a potential difference of approximately 100 kV. This embodiment follows the same arrangement of FIGS. 4a and b. Ion beams 42 are directed toward a cylindrical titanium target 46 where the fusion process takes place and fast neutrons are emitted.

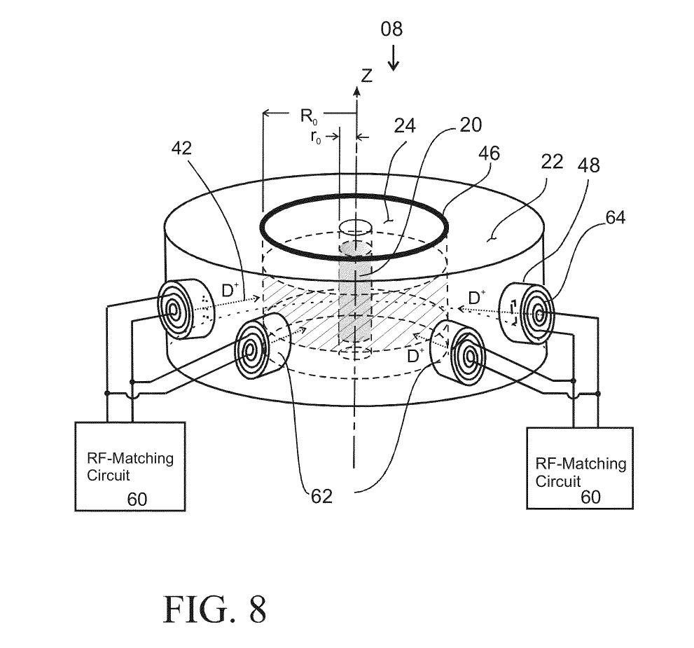

FIG. 8 shows a stylized perspective cross sectional view of thermal neutron source 80 without the fast neutron reflector. RF energy is coupled into the deuterium gas using RF loop antenna 52 in ion chamber 48. The RF energy is optimally coupled from an RF generator to spiral antennal 64 using an RF phase matching circuit 60. The RF energy ionizes the deuterium gas inside spiral antenna ion source 62 into a deuterium-ion plasma 50, resulting in a high atomic content D⁺ and minimal molecular content D₂⁺. Deuterium ions 42 are extracted from plasma 52 by having the cylindrical target 46 at a high negative voltage (e.g. −100 kV). Each spiral antenna ion source 62 has an extraction iris that permits the ions to form an ion beam 42 that can be accelerated toward the cylindrical titanium target 46. In order to minimize the complexity of FIG. 8 and improve visual clarity, the extraction iris, and the electron shield are not shown in FIG. 8. As one skilled in the art knows, these two electrodes are required for the fast neutron generator to operate. The method of moderating the fast neutrons again follows that of the previous discussion given with reference to FIG. 2b. Thermal neutrons are again produced at the sample chamber 20 by the moderation process of the fast neutrons being scattered by the hydrogen atoms in the moderating material.

### The Optimum Conversion of Fast to Thermal Neutrons

The process of converting fast neutrons into thermal neutrons in FIGS. 4a,b,c; 6a,b; 5a,b; and 8 follows the discussion concerning FIG. 2b. Fast neutron conversion to thermal neutrons achieves a maximum flux at sample chamber 20 of cylindrical moderator 24 in these embodiments if the moderator thickness Rₒ-rₒ is optimized as shown in FIG. 3a, depending upon the moderating material selected and the desired ratio of thermal to fast neutrons (as shown in FIG. 3b). These embodiments can be surrounded by a fast neutron reflecting and/or moderating material such as lead or polyethylene; as well as biological radiation shielding for the protection of the public and operator. In all these cases the ion sources or fast neutron generators 28 can be embedded in the lead or other fast neutron reflecting material 22 to maximize efficiency.

### Spherical Arrangements

Arranging fast neutron generators in a spherical arrangement can also increase the available thermal flux at a sample chamber arranged in the center of a spherical moderator. In this embodiment, the fast neutron generators would be arranged in a sphere around a spherical moderator. Using FIGS. 1b and 3b, sample chamber 20 is a sphere of radius rₒ, moderator 24 is a sphere of radius Ro and reflector 22 is a sphere of radius R₁. MCNP calculations give similar analyses in terms of optimizing the flux, but also give an increase in flux over that of the cylindrical case of 1.5×.

### Arrangement for a Prompt Gamma Neutron Activation Analyzer

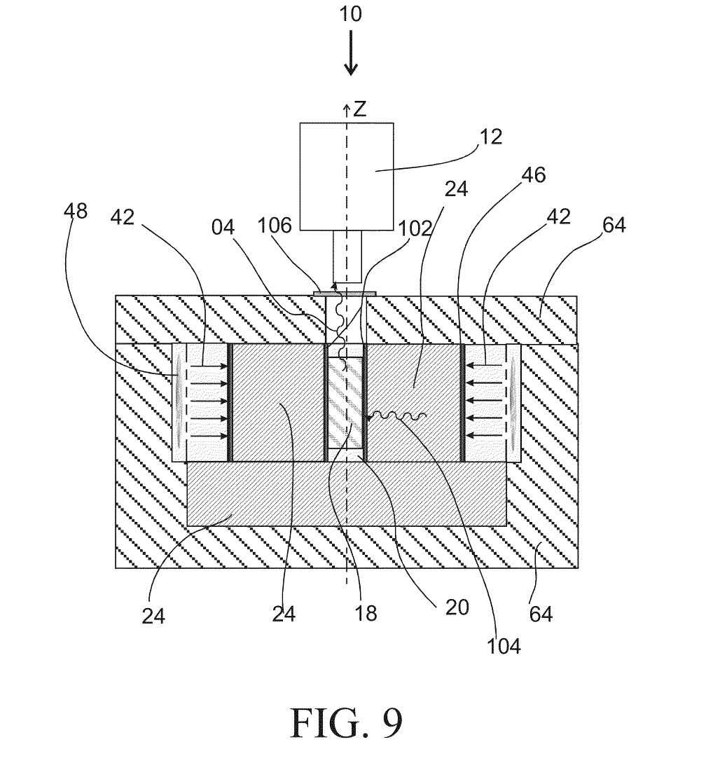

The present invention arrangements of the embodiments of the high flux neutron sources can be used as prompt gamma neutron activation analyzers by placing a gamma-ray detector along the z-axis of the embodiments of the high flux neutron sources (FIGS. 2a, 4a, 6b, 7b, 8). An embodiment of a prompt gamma neutron activation analyzer is shown in a cross sectional view in FIG. 9. The high flux neutron source contains all the elements of the four embodiments with minor additions. A gamma-ray detector 12 is added and used to detect characteristic gamma-rays 04 from sample 18 and analyze their gamma-ray energy spectrum in order to identify and analyze the atomic elements of the sample. High flux neutron source 08 consists of plasma ion beam sources 48 surrounding a cylindrical neutron generating target 46 and sending ion beams in to target 46. This target 46 surrounds and is contiguous with a moderator 24, which surrounds sample 18. In a preferred embodiment, the moderator is made of high density polyethylene (HDPE). Surrounding the plasma ion source 48 is a neutron reflection and shielding means 64. To minimize spurious gamma-rays 104 being generated in moderator 24 from entering gamma-ray detector 12, this arrangement contains an additional element of a gamma-ray or x-ray shielding cylinder 102 that separates the moderator from sample chamber 20. The gamma-ray shielding cylinder 110 is contiguous with the cylindrical moderator and sample chamber 20 and prevents gamma-rays that may be generated in the moderator from directly entering gamma-ray detector 12. For example, if the moderator uses HDPE, the hydrogen in the polyethylene emits a strong line of 2.3 MeV gamma-rays, which can be picked up by the gamma-ray detector and result in an increased noise background due to scattering in the detector. This background in the gamma-ray spectrum will mask the characteristic gamma-ray lines that are being emitted by the atomic elements in sample 18, reducing detection efficiency and increasing the minimum fractional weight of the atomic elements that can be measured. The gamma-ray shielding cylinder 102 prevents spurious gamma-rays 104 from the moderator from coming directly up the z-axis of FIG. 9. Lead or other high density shielding can be used for the gamma-ray shielding cylinder 102. Selection of the material and its thickness depends upon the moderator material. For example, to reduce the 2.3 MeV line from hydrogen (in HDPE), using a cylinder wall thickness of 2 cm of lead for the gamma-ray shielding cylinder will reduce the 2.2 MeV gamma-rays by a factor of approximately 5. The characteristic gamma-rays 04 coming from the sample are not reduced and the overall efficiency of detection is improved. Those skilled in the art know of other materials and wall thicknesses that can be used for the gamma-ray shielding cylinder 102.

To further reduce low energy gamma-rays from entering the gamma-ray detector 12 and causing spurious gamma-ray and x-ray noise, a high pass gamma-ray filter 106 composed of a thin foil can be placed over sample chamber 20. In one embodiment, the thin foil is made of Pb and is thin enough to absorb radiation below approximately 100 to 200 keV in photon energy. The ideal filter is one that stops low energy gammas while passing high energy gamma (hence, “high-pass filter). Those skilled in the art know of other materials and thickness that can be used for this high pass gamma-ray filter 106.

1. An apparatus for producing thermal or epithermal neutrons comprising:
a plurality of sources emitting fast neutrons;
a hollow cylindrical or spherical shape of neutron moderation material with a sample centered within the shape, the material moderating the fast neutrons to thermal neutrons at the sample;
wherein the fast neutron sources are uniformly positioned outside and around the moderation material and thermal neutron flux is maximized at the sample as a function of concentration of fast neutrons from all of the generators, thickness of moderation material and radial distance between the generators, the moderation material and the sample.

2-5. (canceled)

6. An apparatus according to claim 1 wherein the moderation material contains a sample chamber positioned in the center of the moderator.

7. An apparatus according to claim wherein the moderation material is optimized to produce the maximum thermal neutron flux at the sample.

8. An apparatus for producing thermal or epithermal neutrons comprising:
a plurality of ion sources;
a cylindrical fast-neutron-generating target disposed inside the ion sources;
an electron shield disposed around the fast-neutron-generating target and inside the ion sources; the electron shield includes an ion entrance aperture disposed to have ions emitted from the ion source to impact the fast-neutron generating target;
a cylindrical or spherical, hollow moderator disposed inside the fast-neutron-generating target;
a sample chamber centered inside the moderator; and
a neutron reflection and shielding means disposed around the fast neutron generating target;
wherein the fast neutron target is uniformly positioned around the moderator and thermal neutron flux is maximized at the sample as a function of concentration of fast neutrons from the target, thickness of moderation material and radial distance between the target, the moderator and the sample.

9. The apparatus of claim 8 additionally comprising:
a gamma-ray shielding means disposed outside the moderator and whose thickness reduces gamma-ray emission being created in the moderator.

10. An apparatus for producing thermal or epithermal neutrons in a sample comprising:
a plurality of ion sources with ion extraction apertures;
a cylindrical electron shield disposed inside and coaxial to the ion sources;
a cylindrical fast-neutron generating target disposed inside and coaxial to the electron shield that includes an ion entrance aperture disposed to have ions emitted from the ion source impacting the fast-neutron-generating target;
a cylindrical moderator centered inside and coaxial to the cylindrical fast-neutron-generating target; and
a sample chamber centered inside and coaxial to the cylindrical moderator; and
a neutron reflection and shielding means disposed around and coaxial to the ion beam sources;
wherein thermal neutron flux is maximized at the sample as a function of concentration of fast neutrons from the target, thickness of moderation material and radial distance between the target, the moderation material and the sample.

11. An apparatus for producing thermal or epithermal neutrons according to claim 8 wherein the ion sources are microwave-driven ion sources.

12. An apparatus for producing thermal or epithermal neutrons according to claim 8 wherein the ion sources are spiral antenna ion sources.

13. An apparatus for producing thermal or epithermal neutrons according to claim 8 wherein the ion sources are helical antenna ion sources.

14. An apparatus for producing thermal or epithermal neutrons according to claim 8 wherein the ion sources are multicusp ion sources.

15. An apparatus for producing thermal neutrons according to claim 8 wherein the ion sources are deuterium ion sources or tritium ion sources or deuterium and tritium ion source.
